(19) United States
(12) Patent Application Publication
(10) Pub. No.: US 2006/0207819 A1
(43) Pub. Date: Sep. 21, 2006

(54) Double rear traction assembly

(75) Inventor: Denis Boisvert, Grand Mere (CA)

Correspondence Address: WELLS ST. JOHN P.S., 601 W. FIRST AVENUE, SUITE 1300, SPOKANE, WA, 99201, US

(73) Assignee: TATOU Inc.

(21) Appl. No.: 11/372,526

(22) Filed: Mar. 8, 2006

(30) Foreign Application Priority Data
Mar. 15, 2005 (CA) 2,500,695

(51) Int. Cl. B62M 27/02

(52) U.S. Cl. 180/190

(57) ABSTRACT

There is provided an integrated rear traction assembly for a vehicle, comprising a frame comprising a lower member, an upper member, and a frame plate; a plurality of wheels supported by the lower member; a rear sprocket and a front sprocket mounted on the frame plate at an adjustable distance therebetween; and a belt tensioned around the sprockets and wheels.

### CROSS REFERENCE TO RELATED APPLICATIONS

This application claims priority on Canadian application no. 2,500,695, filed on Mar. 15, 2005. All documents above are herein incorporated by reference.

### FIELD OF THE INVENTION

The present invention relates to a double rear traction assembly.

### BACKGROUND OF THE INVENTION

Current double rear traction assemblies are typically assembled on top of rear wheels of vehicle, and usually decrease the driving power efficiency of the vehicles. Moreover, double rear traction assemblies are not currently available for six wheels vehicles.

There is a need in the art for a double rear traction assembly.

### SUMMARY OF THE INVENTION

There is provided an integrated rear traction assembly for a vehicle, comprising a frame comprising a lower member, an upper member, and a frame plate; a plurality of wheels supported by the lower member; a rear sprocket and a front sprocket mounted on the frame plate at an adjustable distance therebetween; and a belt tensioned around the sprockets and wheels

Other objects, advantages and features of the present invention will become more apparent upon reading of the following non-restrictive description of embodiments thereof, given by way of example only with reference to the accompanying drawings.

### BRIEF DESCRIPTION OF THE DRAWINGS

In the appended drawings:

FIGS. 1 show a) a side perspective view and b) a side plan view, of an assembly according to an embodiment of the present invention;

FIG. 2 shows a side plan view of a frame of the assembly of FIG. 1;

FIGS. 3, show a) a first part of a frame plate of the frame of FIG. 2; and b) a second part of the frame plate of the frame of FIG. 2;

FIG. 4 is a detail of anti-friction bearings mounted in the frame plate of FIG. 2;

FIG. 5 is a view of a stiffener member provided between the two parts of the frame plate of the frame of FIGS. 3;

FIG. 6 shows a tensioning means for tensioning a belt of the assembly of FIG. 1;

FIG. 7 shows an adjustment rod of the tensioning means of FIG. 6; and

FIG. 8 show views of a tensioning tube of the tensioning means of FIG. 6.

### DESCRIPTION OF EMBODIMENTS OF THE INVENTION

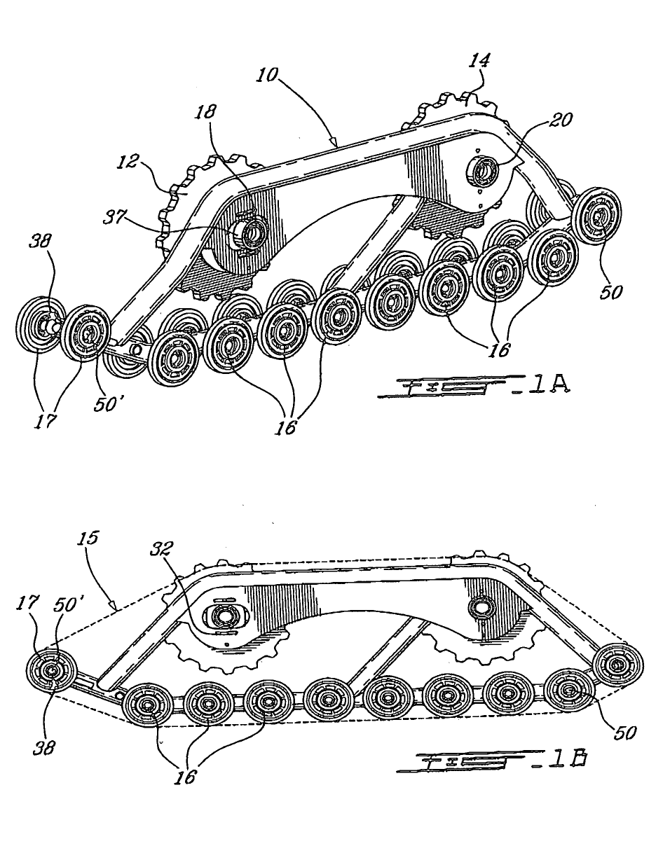

In FIGS. 1 of the appended drawings, there is shown a rear traction assembly, comprising a frame 10 supporting a rear sprocket 12, a front sprocket 14 and wheels 16, and a belt 15 tensioned around the sprockets and wheels (FIG. 1B).

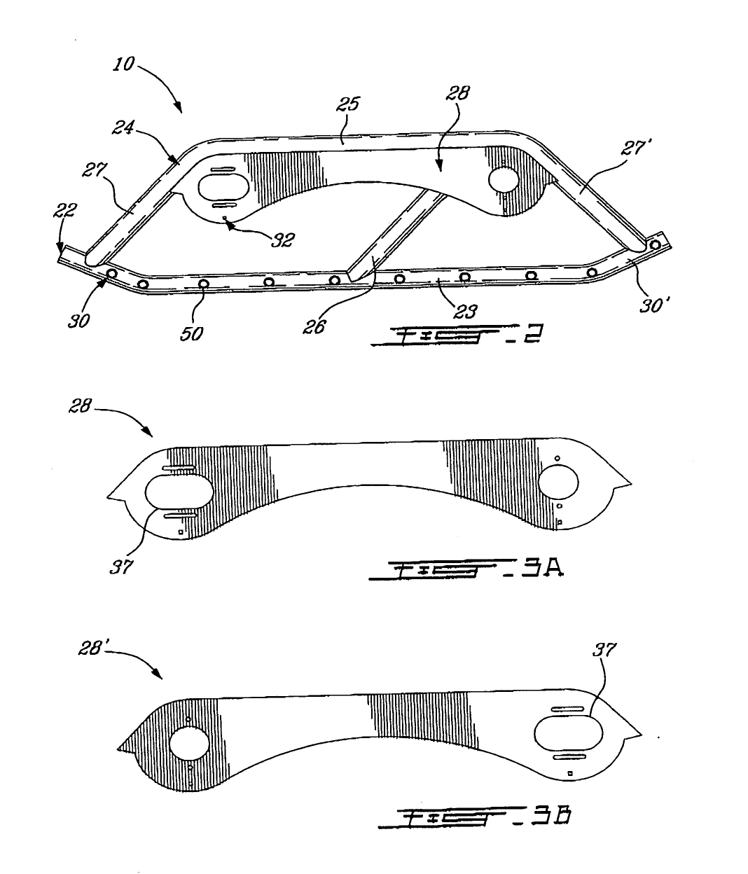

As best seen in FIG. 2, the frame 10 includes a lower member 22, an upper member 24, a middle member 26, and a frame plate 28 (FIGS. 3).

The upper member 24 comprises an upper beam 25 and side arms 27 and 27′. The lower member 22 comprises a lower beam 23 and side arms 30 and 30′. The upper beam 25 and its side arms 27 and 27′ on the one hand, the lower beam 23 and side arms 30 and 30′ on the other hand, may each be a single member shaped so as to have side extremities bent into side arms.

The upper member 24 and the lower member 22 are assembled by connecting the side arms 27 and 30, and 27′ and 30′ respectively, by welding for example.

The middle member 26 further connects the upper member 24 and the lower member 22 by the beams 25 and 23 at positions intermediate between the side arms.

Axles 50 for the wheels 16 are mounted on the lower member 22 (FIG. 1).

The belt 15 is tensioned around the sprockets and wheels. The axis 50′ of rearmost wheels 17 may be mounted on a projecting end tip of the side arm 27 of the lower member 22, which may be used to adjust the tension of the belt 15.

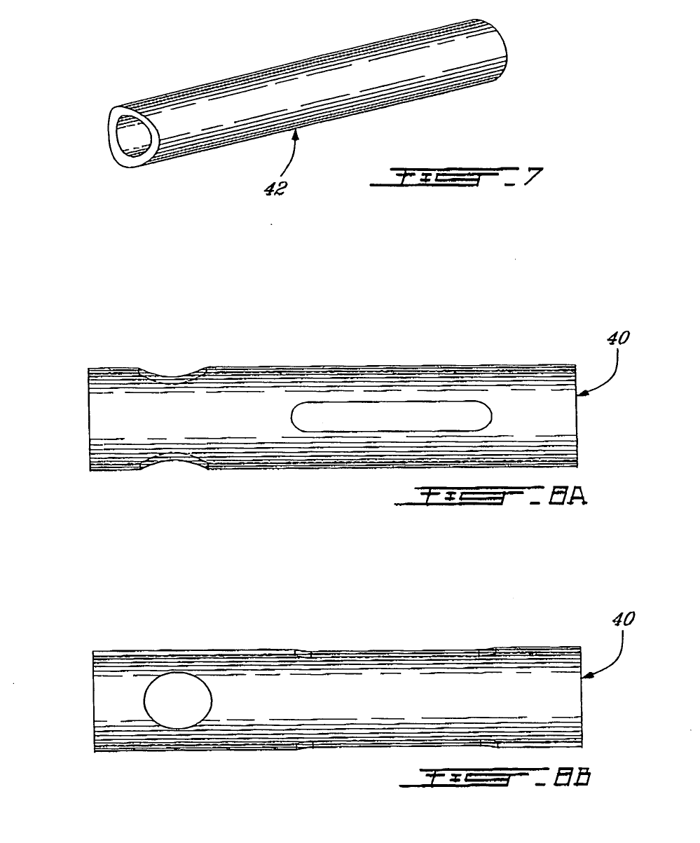

Furthermore, a tensioning means 38 as illustrated in FIG. 6, including a tensioning tube 40 (see FIGS. 8) and an adjustment rod 42 (see FIG. 7) may be supported by the axis 50′.

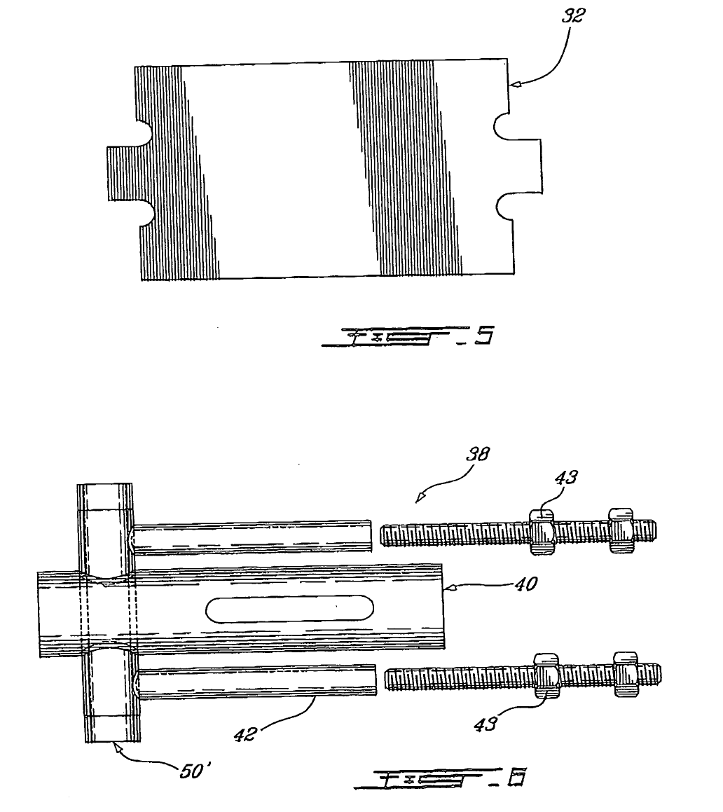

As shown in FIGS. 3, the frame plate of the frame may comprise two parts 28, 28′ assembled on each side of the upper arm 25 of the upper member 24, from the rear sprocket 12 to the rear sprocket 14. A stiffener member 32 may De provided between the two parts 28, 28′ for strengthening the assembly (FIGS. 1b and 5).

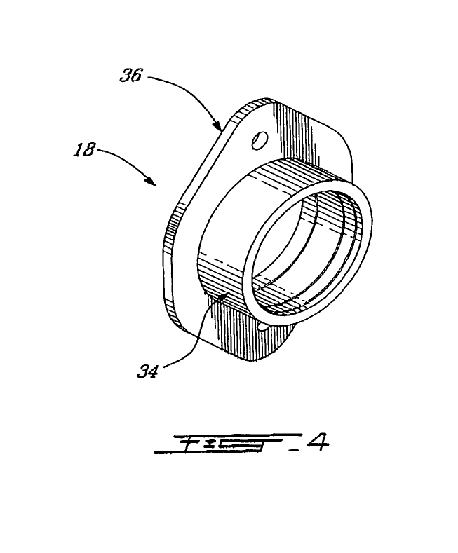

The rear sprocket 12 is mounted on the frame plate by anti-friction bearings 18. FIG. 4 shows details of the anti-friction bearings 18, comprising a hub 34 and a hub support 36 mounted in a slot 37 provided in the frame plate, so that the position of the rear sprocket 12 is adjustable along an available length of the slot 37.

Thus, the lower member 22 and the upper member 24 are assembled together into a generally trapezoidal shape, reinforced by the middle member 26, and supporting the frame plate, a distance between the front sprocket 14 and the rear sprocket 12 being adjustable by adjustment of the position of the rear sprocket 12.

Therefore, there is provided a rear traction assembly for a vehicle, comprising two sprockets and their own hub, for a maximized power of the vehicle.

This double rear traction assembly is an integrated rear traction assembly and is adaptable to a range of vehicles, including ATV for example.

It is found that the rear traction assembly according to the present invention allows an increased traction sweep and an efficient approach angle for vehicle operating on grounds such as snow and mud, and therefore allows the vehicles an improved traction on such grounds.

Although the present invention has been described hereinabove by way of embodiments thereof, it may be modified, without departing from the nature and teachings of the subject invention as defined in the appended claims.

What is claimed is:

1. A double rear traction assembly for a vehicle, comprising:
a frame comprising a lower member, an upper member, and a frame plate;
a plurality of wheels supported by said lower member;
a rear sprocket and a front sprocket mounted on said frame plate at an adjustable distance therebetween; and
a belt tensioned around the sprockets and wheels.

2. The double rear traction assembly of claim 1, wherein respective hubs of said rear sprocket and said front sprocket are mounted on said frame plate, a position of the hub of said rear sprocket being adjustable along a length of a slot of said frame plate for adjusting the distance between said rear sprocket and said front sprocket.

3. The double rear traction assembly of claim 2, wherein said respective hubs of said rear sprocket and said front sprocket are mounted on said frame plate using anti-friction bearings.

4. The double rear traction assembly of claim 1, wherein said upper member comprises an upper beam with downwardly curved rear and front extremities; said lower member comprises a lower beam with upwardly rear and front curved extremities, said upper member and said lower member being assembled by their respective rear and front curved extremities.

5. The double rear traction assembly of claim 1, wherein said upper member and said lower member are welded together into a trapezoidal shape.

6. The double rear traction assembly of claim 1, wherein said frame further comprises a middle member connecting said upper member and said lower member.

7. The double rear traction assembly of claim 1, wherein axles for the wheels are mounted on the lower member.

8. The double rear traction assembly of claim 4, wherein axles of rearmost wheels are mounted on a projecting end tip of the rear curved extremity of the lower member.

9. The double rear traction assembly of claim 1, comprising a belt tensioning means.

8. The double rear traction assembly of claim 1, wherein said frame plate comprises too parts assembled on each side of the upper member, from the rear sprocket to the rear sprocket.

9. A vehicle provided with the double rear traction assembly of claim 1.
